(19) United States
(12) Patent Application Publication
(10) Pub. No.: US 2010/0154380 A1
(43) Pub. Date: Jun. 24, 2010

(54) Control system for a land-based simple cycle hybrid engine for power generation

(75) Inventors: Venkat Eswarlu Tangirala, Niskayuna, NY (US); Narendra Digamber Joshi, Schenectady, NY (US); Adam Rasheed, Glenville, NY (US); Kevin Michael Hinckley, Hanover, NH (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/317,350

(22) Filed: Dec. 22, 2008

(51) Int. Cl. F02C 9/48; F02C 9/28

(52) U.S. Cl. 60/39.27; 60/772; 701/100

(57) ABSTRACT

A pulse detonation combustor (PDC)-based hybrid engine control system includes a programmable controller directed by algorithmic software to control a rotational shaft speed of the PDC-based hybrid engine, an air inlet valve rotational speed for the PDC, and a fuel fill time period for the PDC in response to a corresponding low pressure turbine (LPT) shaft speed signal or a power difference signal based on a difference between desired power and actual power produced by the PDC-based hybrid engine and further in response to a fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

### BACKGROUND

The invention relates generally to pulse detonation engines, and more particularly to a ground-based simple cycle pulse detonation combustion (PDC) engine for power generation that includes a control system and method for controlling start-up, shutdown and ramp-up/down power produced by the pulse detonation combustor-based hybrid engine.

Pulse detonation combustors create high pressure and temperature detonation waves by combusting a mixture of gas (typically air) and a hydrocarbon fuel. The detonation waves exit pulse detonation combustor tubes as pulses, thus providing thrust.

With the recent development of pulse detonation combustors (PDCs) and engines (PDEs), various efforts have been underway to use PDC/Es in practical applications, such as in aircraft engines and/or as means to generate additional thrust/propulsion, such as in ground based power generation systems. Further, there are efforts to employ PDC/E devices into “hybrid” type engines which use a combination of both conventional gas turbine engine technology and PDC/E technology in an effort to maximize operational efficiency. It is for either of these applications that the following discussion will be directed. It is noted that the following discussion will be directed to “pulse detonation combustors” (i.e. PDCs). However, the use of this term is intended to include pulse detonation engines, and the like.

Recognizing that detonation initiation may not be achievable in fuel-air mixtures of interest at low pressure and low temperature combustor inlet conditions, it would be advantageous to provide a mechanism for ramping up the power produced by a PDC-based hybrid engine until the combustor inlet pressure and temperature enable detonation initiation of the fuel-aid mixtures.

### BRIEF DESCRIPTION

Briefly, in accordance with one embodiment of the invention, a pulse detonation combustor (PDC)-based hybrid engine control system comprises a programmable controller directed by algorithmic software to control a rotational shaft speed of a PDC-based hybrid engine, an air inlet valve rotational speed for the PDC, and a fuel fill time period for the PDC in response to a power difference signal based on a difference between desired power and actual power produced by the PDC-based hybrid engine and further in response to a fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

According to another embodiment of the invention, a pulse detonation combustor (PDC)-based hybrid engine control system comprises a programmable controller directed by algorithmic software to control a rotational shaft speed of a PDC-based hybrid engine, an air inlet valve rotational speed for the PDC, and a fuel fill time period for the PDC in response to a corresponding low pressure turbine (LPT) shaft speed and further in response to a fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

According to yet another embodiment of the invention, a pulse detonation combustor (PDC)-based hybrid engine comprises:

a turbine and a compressor configured together as a single spool engine with a common rotational shaft;

a PDC comprising a plurality of multitube pulse discharge combustors configured to provide a temporally uniform load balance and a spatially uniform load balance on the turbine; and

a control system comprising a programmable controller directed by algorithmic software to control the rotational shaft speed, an air inlet valve rotational speed for the PDC, and a fuel fill time period for the PDC in response to a power difference signal based on a difference between desired power and actual power produced by the PDC-based hybrid engine and further in response to a fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

According to still another embodiment of the invention, a pulse detonation combustor (PDC)-based hybrid engine comprises:

a turbine and a compressor configured together as a single spool engine with a common rotational shaft;

a PDC comprising a plurality of multitube pulse discharge combustors configured to provide a temporally uniform load balance and a spatially uniform load balance on the turbine; and

a control system comprising a programmable controller directed by algorithmic software to control the rotational shaft speed, an air inlet valve rotational speed for the PDC, and a fuel fill time period for the PDC in response to a corresponding low pressure turbine (LPT) shaft speed and further in response to a fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

According to still another embodiment of the invention, a method of controlling a pulse detonation combustor (PDC)-based hybrid engine comprises:

generating a power difference signal based on a difference between desired power and actual power produced by a PDC-based hybrid engine;

generating a fuel fill time signal for the PDC; and

controlling a rotational shaft speed of the PDC-based hybrid engine, an air inlet valve rotational speed for the PDC, and a fuel fill time period for the PDC in response to the power difference signal and the fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

According to still another embodiment of the invention, a method of controlling a pulse detonation combustor (PDC)-based hybrid engine comprises:

generating a corresponding low pressure turbine (LPT) shaft speed signal for the PDC-based hybrid engine;

generating a fuel fill time signal for the PDC; and

controlling a rotational shaft speed of the PDC-based hybrid engine, an air inlet valve rotational speed for the PDC, and a fuel fill time period for the PDC in response to the the corresponding LPT shaft speed signal and the fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

### DRAWINGS

These and other features, aspects, and advantages of the present invention will become better understood when the following detailed description is read with reference to the accompanying drawings in which like characters represent like parts throughout the drawings, wherein:

FIG. 1 is a simplified system block diagram illustrating a land-based simple cycle pulse detonation combustor (PDC)-based hybrid engine for power generation, according to one embodiment of the invention;

FIG. 2 is a cross-sectional axial view of the PDC depicted in FIG. 1, according to one embodiment of the invention;

FIG. 3 is a diagram illustrating a control system for controlling the PDC-based hybrid engine depicted in FIG. 1 during start-up, shutdown, and for controlling ramp-up and ramp-down of the power produced by the hybrid engine, according to one embodiment of the invention;

FIG. 4 is a diagram illustrating the phases of the PDC-based hybrid engine operation controlled by the control system depicted in FIG. 3; and

FIG. 5 is a flow chart illustrating a method of controlling a PDC-based hybrid engine, according to one embodiment of the invention.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

Increasing or decreasing power delivered from a conventional gas turbine engine can be achieved simply by monitoring the engine rotational speed and mass flow rate, and increasing or decreasing the amount of fuel with respective increasing or decreasing engine rotational speed to achieve a desired output power. A PDC-based hybrid engine however, requires controlling more operational variables than that required by conventional gas turbine engines to generate a desired increase or decrease in generated engine power.

Increasing or decreasing power power delivered from a PDC-based engine still requires increasing or decreasing the engine rotational speed. Additionally, a PDC-based engine requires modulating the frequency of PDC operation to provide for the respective increased or decreased output power. One example would be operating the PDC at 10 pulses per second to achieve 10% engine output power, 50 pulses per second to achieve 50% engine output power, 100 pulses per second to achieve 100% engine output power, and so on. Of course the PDC pulsation rate will depend on many factors including, for example, the type and size of the PDC-based hybrid engine and can be, for example, determined heuristically based on actual test data or historical data.

According to particular embodiments described in further detail below, a PDC pulsation rate is achieved by modulating an air inlet valve open time period for the PDC, and a fuel fill time period for the PDC in response to a power difference signal based on a difference between desired power and actual power produced by the PDC-based hybrid engine and further in response to a fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

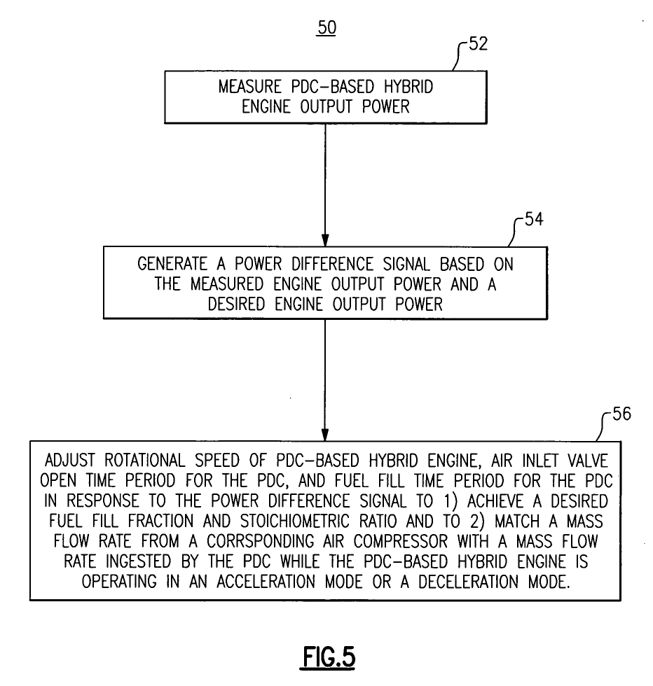

FIG. 5 is a flow chart illustrating a method of controlling a PDC-based hybrid engine, according to one embodiment of the invention. The PDC-based hybrid engine output power is first measured as represented in block 52. A power difference signal based on the measured engine output power and a desired engine output power is then generated as represented in block 54. Finally, as represented in block 56, the rotational speed of the PDC-based hybrid engine, the air inlet valve open time period, and the fuel fill time period for the PDC based on a fuel fill time signal, are adjusted in response to the power difference signal to 1) achieve a desired fuel fraction and stoichiometric ratio and to 2) match a mass flow rate from a corresponding air compressor with a mass flow rate ingested by the PDC while the PDC-based hybrid engine is operating in an acceleration mode or a deceleration mode.

The embodiments described herein with reference to the figures are based upon the following assumptions:

i. The hybrid engine has several bundles; and each bundle is a multitube PDC comprising at least 4 tubes. The number of bundles is chosen such that the load balance on the turbine is temporally uniform. The number of tubes is chosen such that the load balance on the turbine is spatially uniform.

ii. Each PDC comprises a valved-air stream and valved-fuel stream. The fueling time can be dialed in independent of the air valve rotation speed.

iii. The turbine and compressor are mounted on the same shaft (single spool).

iv. Valved rotational speed is uniform and continuous in the azimuthal direction at a given load on the turbine.

v. The PDC tube in purged completely. No residual combustion products remain in the PDC tube. Purge fraction+fueled fraction=1.0.

vi. Fill Mach Number˜0.3 (minimize fill losses) and is determined by the fill time available at a given frequency and the combustor inlet conditions.

vii. Quasi-detonations (detonations+high speed deflagrations).

Those skilled in the art will readily appreciate the foregoing assumptions may or may not apply to other power generation engine embodiments that are structured and that operate according to the novel principles described herein.

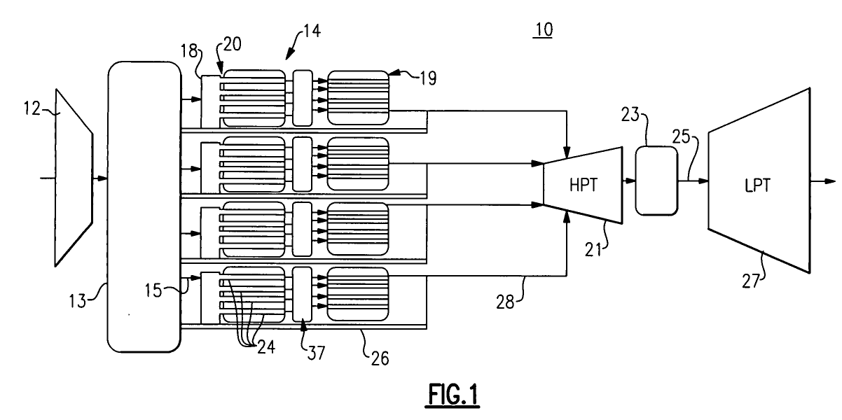

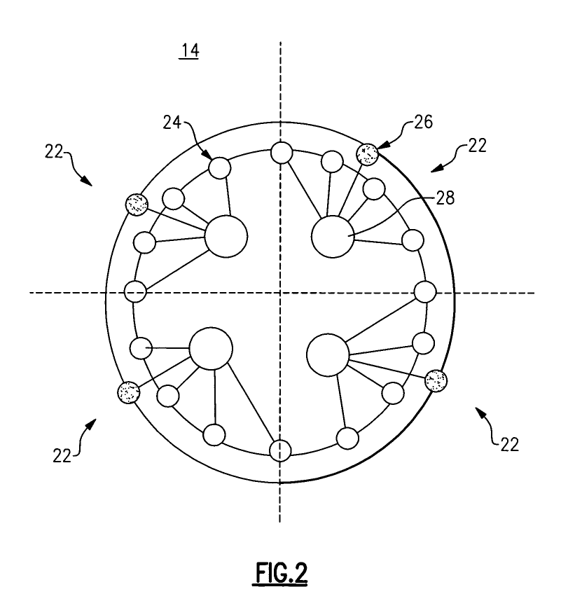

FIG. 1 is a simplified system block diagram illustrating a land-based simple cycle pulse detonation combustor (PDC)-based hybrid engine 10 for power generation, according to one embodiment of the invention. A compressor 12 generates and supplies compressed air to the PDC 14 via a plenum 13. The supply of compressed air to the PDC bundle tubes 24 is controlled via a corresponding air inlet valve 18 that may be, for example, a rotational type valve. Fuel supplied downstream from the air inlet valve 18 to each PDC bundle tube 24 is controlled via a corresponding fuel inlet valve 20. The resultant air/fuel mixture passes through the PDC bundles 22 depicted in further detail in FIG. 2, and exits through corresponding gas nozzles 37 into PDC tube extensions 19 that are configured to transmit the resultant air/fuel mixture to a high pressure turbine 21 via turbine inlets 28. The resultant air/fuel mixture exiting the high pressure turbine is then transmitted via a plenum 23 to a low pressure turbine 27. Compressed air from the compressor 12 is also transmitted to the high pressure turbine inlets 28 via deflagration combustor tubes 26.

FIG. 2 is a cross-sectional axial view of the PDC combustor 14 depicted in FIG. 1, according to one embodiment of the invention. The PDC combustor 14 can be seen to comprise four bundles 22, each with four PDC tubes 24 and a single deflagration combustor tube 26. Each bundle 22 delivers a fuel/air mixture into a corresponding turbine inlet 28. The PDC tubes 24 are arranged in a circular fashion to provide a balanced load on the high pressure turbine during firing of the PDC 14.

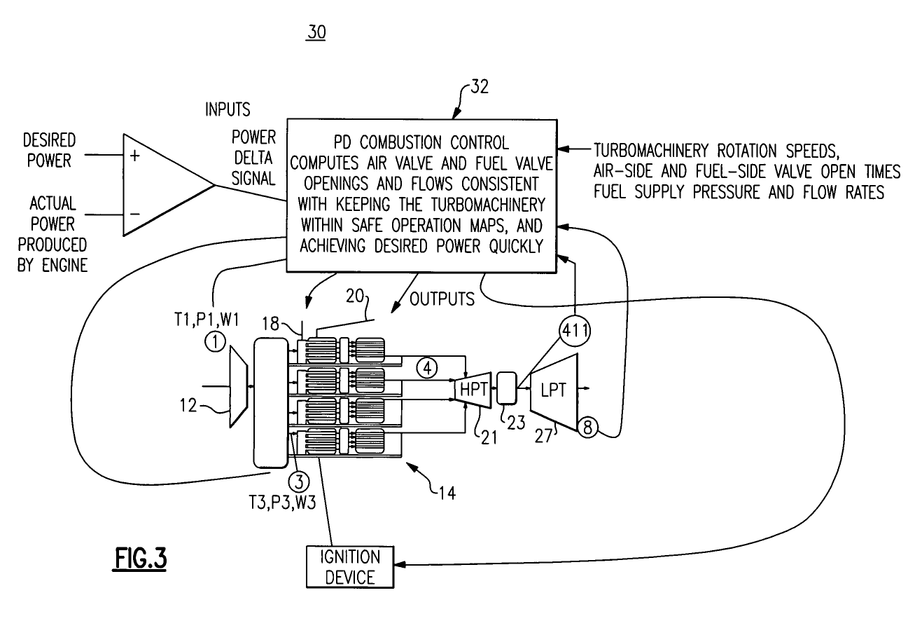

FIG. 3 is a diagram illustrating a control system 30 for controlling the PDC-based hybrid engine 10 depicted in FIG. 1 during start-up and shutdown, and for controlling ramp-up and ramp-down of the power produced by the hybrid engine, according to one embodiment of the invention. A controller 32 is configured to control the speed of the turbomachinery that comprises compressor 12, PDC 14 and turbines 21, 27. Controller 32 is also configured to control rotational speed of the air inlet valve 18 and the fuel fill time via fuel inlet valve 20. Controller 32 is directed via algorithmic software that determines the desired turbomachinery speed, air inlet valve rotational speed and fuel fill time in response to fixed set points and sensing variables.

Fixed set points used by the algorithmic software may include, without limitation, desired output power as a percentage of the rated PDC-based hybrid engine power, fuel fill fraction, fuel purge fraction, and stoichiometric ratio. Sensing variables used by the algorithmic software may include, without limitation, fuel fill length, fuel supply pressure, fuel flow rates, and generated power.

The power generated via the PDC-based hybrid engine can be determined and controlled using one or more control limit techniques familiar to those skilled in the art of power generation engines. These control limits may include, without limitation, speed limits, pressure limits, temperature limits, and/or mass flow limits. Further details of such known control limit techniques are not discussed herein for brevity and to improve clarity regarding the principles described herein.

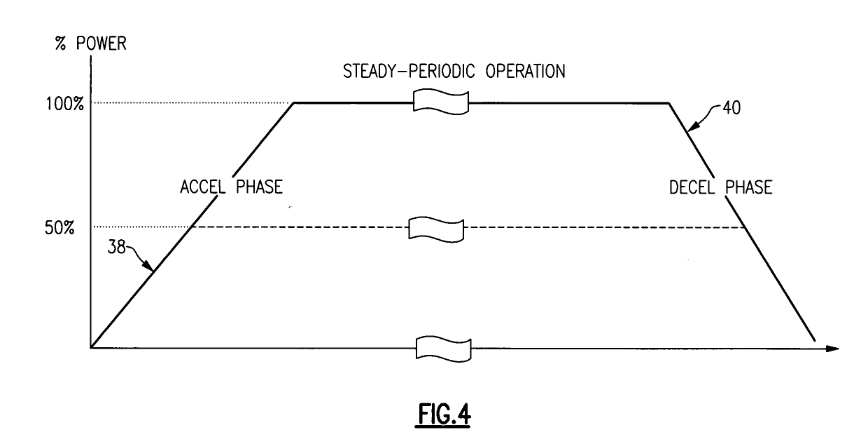

FIG. 4 is a diagram illustrating the respective acceleration and deceleration phases 38, 40 of the PDC-based hybrid engine operation controlled by the controller 32 depicted in FIG. 3. During acceleration mode 38, the turbomachinery speed N is ramped up to the speed corresponding to the desired percentage of rated power conditions. This action increases the mass flow rate (˜N) through the system to the mass flowrate corresponding to the desired percentage of rated power conditions.

During deceleration mode 40, the turbomachinery speed N that scales as N³ according to one aspect of the invention, is ramped down to the speed corresponding to the desired percentage of rated power conditions. This action decreases the mass flow rate (˜N) through the system to the mass flowrate corresponding to the desired percentage of rated power conditions.

Relationships represented by equations 1-15 below according to particular embodiments, are used by the algorithmic software to direct controller 32 to control the turbomachinery speed N, air inlet valve 18 rotational speed θᵥₐₗᵥₑ, and fuel inlet valve 20 fuel fill time t_{ff}. Fuel fill time t_{ff} is determined via a fuel sensor 42 that maintains the fuel fill fraction. The purge time t_{purge} is also known since the fuel fill time t_{ff} is fixed. Alternatively, V_{fill} can be determined using the relationships defined by equations (3), (7), (8) and (14) below, allowing the fuel fill time t_{ff} to also be determined using the relationship represented by equation (13) below.

$$\begin{matrix}{W}_{net} = f ( ff , φ , cr ) & ( 1 ) \\ {m}^{o} = f ( N ) = f ( cr ) = f ( f ) & ( 2 ) \\ cr = \frac{{P}_{3}}{{P}_{1}} = f ( N ) = f ( f ) & ( 3 ) \\ pf + ff = 1 ; pf = \frac{{t}_{purge}}{{t}_{purge} + {t}_{ff}} & ( 4 ) \\ {{θ}_{valve}}^{o} = f ( f ) = f ( cr ) = f ( N ) & ( 5 ) \\ {m}^{o} = {ρ}_{fill} {A}_{t} {V}_{fill} = \frac{{P}_{3}}{{P}_{1}} {RT}_{3} {A}_{t} {V}_{fill} & ( 6 ) \\ {V}_{fill} = {M}_{fill} γ {RT}_{3} & ( 7 ) \\ {M}_{fill} = 0.3 & ( 8 ) \\ {t}_{cycle} = \frac{1}{f} & ( 9 ) \\ {t}_{cycle} = {t}_{VO} + {t}_{DIP} + {t}_{BD} & ( 10 ) \\ {t}_{VO} = {t}_{purge} + {t}_{ff} & ( 11 ) \\ {t}_{DIP} = {t}_{DI} + {t}_{DP} & ( 12 ) \\ {t}_{ff} = \frac{{L}_{tube}}{{V}_{fill}} & ( 13 ) \\ γ = f ( T , [ conc ] ) & ( 14 ) \\ {C}_{p} = f ( T , [ conc ] ) & ( 15 )\end{matrix}$$

The time when the static pressure inside the PDC combustion chamber is equal to or less than the upstream total pressure with respect to a reference time is represented in equation (11) as t_{VO}, where the reference time is the time at which valve 18 is closed and when the spark is initiated via a spark ignition device 44. The ratio t_{VO}/t_{cycle} is fixed, and t_{cycle}˜f˜θᵥₐₗᵥₑ. Thus, for a given power level, t_{VO} scales as a function of the turbomachinery speed N as can be seen from equations (3), (9), (10) and (11) above.

In summary explanation, a pulse detonation combustor (PDC)-based hybrid engine includes a control system 30 comprising a programmable controller 32 directed by algorithmic software to control a rotational shaft speed of the PDC-based hybrid engine 10, an air inlet valve 18 open time period for the PDC 14, and a fuel fill time period for the PDC 14 in response to a power difference signal based on a difference between desired power and actual power produced by the PDC-based hybrid engine 10 and further in response to a fuel fill time signal for the PDC 14, such that a desired fuel fill fraction and stoichiometric ratio are maintained and further such that a mass air flowrate from an air compressor 12 matches a mass air flowrate ingested via the PDC 14 while the PDC-based hybrid engine 10 is operating in an acceleration mode or a deceleration mode.

The control variables including speed N of the turbomachinery, air inlet valve 18 rotational speed θᵥₐₗᵥₑ, and fuel fill time t_{ff} are then ramped up during the acceleration phase 38 as the power generated is ramped up to the specified percentage of rated power value. The effect of controlling these variables is to match mass flowrate from the compressor 12, which varies directly with compressor speed N, to the mass flowrate that can be ingested by the PDC 14. This is achieved by varying the respective air inlet valve 18 and fuel inlet valve switching frequencies θᵥₐₗᵥₑ, t_{ff}.

The PDC-based hybrid engine power can be ramped up or down in discrete intervals that may be, for example, 10% intervals, all the way up to 100% power conditions, using the system and methods described herein. Ramping up is achieved by starting in deflagration mode as the combustor inlet pressure and temperature increase until pulse detonation operation is feasible. Ramping down is achieved by starting in pulse deflagration mode as the combustor inlet pressure and temperature decrease until only deflagration mode is feasible.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A pulse detonation combustor (PDC)-based hybrid engine control system comprising a programmable controller directed by algorithmic software to control a rotational shaft speed of a PDC-based hybrid engine, an air inlet valve rotational speed for the PDC, and a fuel fill time period for the PDC in response to a power difference signal based on a difference between desired power and actual power produced by the PDC-based hybrid engine and further in response to a fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

2. The PDC-based hybrid engine control system according to claim 1, further comprising a shaft speed sensor configured to generate a rotational shaft speed signal for the PDC-based hybrid engine such that the algorithmic software controls the rotational shaft speed of the PDC-based hybrid engine further based on the rotational shaft speed signal.

3. The PDC-based hybrid engine control system according to claim 1, further comprising a fuel inlet valve sensor configured to generate the fuel fill time signal.

4. The PDC-based hybrid engine control system according to claim 1, wherein the PDC-based hybrid engine comprises a plurality of multitube pulse discharge combustors configured to provide a temporally uniform load balance and a spatially uniform load balance on a corresponding turbine.

5. The PDC-based hybrid engine control system according to claim 1, wherein the fuel fill time period is independent of the air inlet valve rotational speed.

6. The PDC-based hybrid engine control system according to claim 1, wherein the air inlet valve rotational speed is uniform and continuous in the azimuthal direction at a given load on a corresponding turbine.

7. The PDC-based hybrid engine control system according to claim 1, wherein the programmable controller is further directed by algorithmic software to control initiation of a spark in response to closing of a PDC fuel inlet valve.

8. A pulse detonation combustor (PDC)-based hybrid engine control system comprising a programmable controller directed by algorithmic software to control a rotational shaft speed of a PDC-based hybrid engine, an air inlet valve rotational speed for the PDC, and a fuel fill time period for the PDC in response to a corresponding low pressure turbine (LPT) shaft speed and further in response to a fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

9. The PDC-based hybrid engine control system according to claim 8, wherein the PDC-based hybrid engine comprises a plurality of multitube pulse discharge combustors configured to provide a temporally uniform load balance and a spatially uniform load balance on a high pressure turbine.

10. The PDC-based hybrid engine control system according to claim 8, wherein the fuel fill time period is independent of the air inlet valve rotational speed.

11. The PDC-based hybrid engine control system according to claim 8, wherein the air inlet valve rotational speed is uniform and continuous in the azimuthal direction at a given load on a corresponding turbine.

12. The PDC-based hybrid engine control system according to claim 8, wherein the programmable controller is further directed by algorithmic software to control initiation of a spark in response to closing of a PDC fuel inlet valve.

13. A pulse detonation combustor (PDC)-based hybrid engine comprising:
a turbine and a compressor configured together as a single spool engine with a common rotational shaft;
a PDC comprising a plurality of multitube pulse discharge combustors configured to provide a temporally uniform load balance and a spatially uniform load balance on the turbine; and
a control system comprising a programmable controller directed by algorithmic software to control the rotational shaft speed, an air inlet valve rotational speed for the PDC, and a fuel fill time period for the PDC in response to a power difference signal based on a difference between desired power and actual power produced by the PDC-based hybrid engine and further in response to a fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

14. The PDC-based hybrid engine according to claim 13, wherein the fuel fill time period is independent of the air inlet valve rotational speed.

15. The PDC-based hybrid engine according to claim 13, wherein the air inlet valve rotational speed is uniform and continuous in the azimuthal direction at a given load on a corresponding turbine.

16. A pulse detonation combustor (PDC)-based hybrid engine comprising:
a turbine and a compressor configured together as a single spool engine with a common rotational shaft;
a PDC comprising a plurality of multitube pulse discharge combustors configured to provide a temporally uniform load balance and a spatially uniform load balance on the turbine; and
a control system comprising a programmable controller directed by algorithmic software to control the rotational shaft speed, an air inlet valve rotational speed for the PDC, and a fuel fill time period for the PDC in response to a corresponding low pressure turbine (LPT) shaft speed and further in response to a fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

17. The PDC-based hybrid engine according to claim 16, wherein the fuel fill time period is independent of the air inlet valve rotational speed.

18. The PDC-based hybrid engine according to claim 16, wherein the air inlet valve rotational speed is uniform and continuous in the azimuthal direction at a given load on a corresponding turbine.

19. A method of controlling a pulse detonation combustor (PDC)-based hybrid engine, the method comprising:
generating a power difference signal based on a difference between desired power and actual power produced by a PDC-based hybrid engine;
generating a fuel fill time signal for the PDC; and
controlling a rotational shaft speed of the PDC-based hybrid engine, an air inlet valve rotational speed for the PDC, and a fuel fill time period for the PDC in response to the power difference signal and the fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

20. The method of controlling a PDC-based hybrid engine according to claim 19, further comprising determining the actual power produced by the PDC-based hybrid engine in response to a control limit selected from a temperature limit, a pressure limit, a speed limit, or a mass flow rate limit.

21. A method of controlling a pulse detonation combustor (PDC)-based hybrid engine, the method comprising:
generating a corresponding low pressure turbine (LPT) shaft speed signal for the PDC-based hybrid engine;
generating a fuel fill time signal for the PDC; and
controlling a rotational shaft speed of the PDC-based hybrid engine, an air inlet valve rotational speed for the PDC, and a fuel fill time period for the PDC in response to the the corresponding LPT shaft speed signal and the fuel fill time signal for the PDC, such that a desired fuel fill fraction and stoichiometric ratio are maintained and further such that a mass air flowrate from an air compressor matches a mass air flowrate ingested via the PDC while the PDC-based hybrid engine is operating in an acceleration mode or a deceleration mode.

22. The method of controlling a PDC-based hybrid engine according to claim 21, further comprising determining the actual power produced by the PDC-based hybrid engine in response to a control limit selected from a temperature limit, a pressure limit, a speed limit, or a mass flow rate limit.
